(19) United States
(12) Patent Application Publication
(10) Pub. No.: US 2006/0069690 A1
(43) Pub. Date: Mar. 30, 2006

(54) Electronic file system graphical user interface

(76) Inventors: Parag Patel, Marina Del Rey, CA (US); Alok K. Gupta, Venice, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/231,152

(22) Filed: Sep. 20, 2005

Related U.S. Application Data
(63) Continuation-in-part of application No. 10/945,455, filed on Sep. 20, 2004.
(63) Continuation-in-part of application No. 10/985,363, filed on Nov. 10, 2004.

(51) Int. Cl. G06F 7/00

(52) U.S. Cl. 707/100

(57) ABSTRACT

A research software tool for use with an online external resource comprises a flowchart graphic user interface configured to be displayed on an electronic display. The flowchart graphic user interface includes a graphically indicated first defined area and a text string displayable therein. The flowchart graphic user interface further includes a graphically indicated second defined area and a text string displayable therein, at least one of the text strings being user selectable. The flowchart graphic user interface further includes relationship symbology displayable between the first and second defined areas and a user selectable link corresponding to one of the text strings. The user selectable link is an active link that is configured to interface with the online external resource, and that includes a search criterion related to at least one of the text strings, for use with the online external resource.

### CROSS-REFERENCE TO RELATED APPLICATIONS

This application is a continuation-in-part of U.S. patent application Ser. No. 10/945,455 (filed 20 Sep. 2004) and U.S. patent application Ser. No. 10/985,363 (filed 10 Nov. 2004). The entire disclosure of these priority applications is hereby incorporated by reference herein.

### FIELD OF THE INVENTION

The present invention relates generally to an electronic content management system, and more specifically to an electronic content management system having a flowchart-based graphical user interface.

### BACKGROUND OF THE INVENTION

There are a variety of graphic user interface formats for electronic file systems. A common graphic user interface involves a user to being able to interact with electronic files that are organized and stored in folders and subfolders. Folders and electronic files may be initially stored in a main index or directory. These may be listed in alphabetical order, by file/folder size, file type, or date the file was last saved for example. In addition, within a given folder there may be contained subfolders and electronic files that may also be listed in alphabetical order of file/folder name, by file/folder size, file type, date the files were last saved, or by alphabetical order by author, for example. Typically the user does not have control in the ordering of such files/folders except by specifying how all of the files in a given folder are to be presented (for example, by alphabetical order, in alphabetical order of file/folder name, by file/folder size, and so forth). In a Windows® format, electronic files and folders may be graphically presented in a display window with the user able to position such files and folders.

Whether indexed or presented graphically in a window, the relationship between various folders is not readily apparent. As such the task of determining a specific folder to store a given electronic file/folder/subfolder or where to seek the location of a given file/folder/subfolder may become complex and unnecessarily time-consuming. Accordingly, there is a need in the art for an improved graphic user interface for an electronic file system.

Through the use of complex computer networks, such as the Internet, researchers have access to a vast amount of resources virtually at their fingertips. Such online resources, also referred to as knowledge stores, usually take the form of computer servers containing databases. These online resources may be operated by private, charitable and governmental entities. Access to the online resources is typically through an associated website. The online resources may be freely accessed or are proprietary in nature requiring a fee. Efficiently navigating to such online resources is a topic of concern.

In the case of legal research for example, a research attorney may consult a treatise on a given topic or issue of concern, such as the rules of civil procedure. Such a treatise may be in hardcopy or an electronic version. Using the treatise, the researcher would begin with a visual scan or browse the many pages of a table of contents or index at the back of the treatise. Through trial and error the researcher would have to consult the referenced portions of the treatise until he/she has found issue relevant content or text. Often such relevant content or text would provide cross references to other resources. In the case of legal research, citations may be made to a legal case law opinion, a governmental or non-governmental agency no-action or opinion letter or memorandum, a portion of a statute or regulation, or to a portion of another treatise for example. Where the treatise is electronic form, such citations may be active links or hyperlinks to such citations. Such links may connect to content that is hosted by an online resource that may or may not be operated by the same operator that maintains the electronic version of the treatise being used. These links may include a highlighted text string that can be selected by the user (such as by clicking with a mouse) and configured to link with a specific web page or computer file.

Another typical online research approach would be to locate and access content that is hosted on online resources using a “search engine.” A search engine is a computer program that receives key words as user inputs and performs an online search of various online resources to locate content related to the inputted key words. A key word search is typically Boolean search that utilizes key words (also referred to as parameters or search terms). The matched content may reside in databases maintained by the search engine operator itself or may reside externally as hosted by some other online resource. The efficiency of the key word searching is highly dependent upon the user inputting the appropriate “key words.”

Another online research approach would be to search in specific known databases. Such databases may reside at online resources that are freely accessed or proprietary in nature requiring a fee (for example, Lexis/Nexis® or Westlaw®). These online resources may facilitate their content to be located through a key word search in one or more of several topical hierarchically-organized databases (for example, “ALLFEDS” in the Westlaw® databases) or through a proprietary classification system (for example, “keynotes” in the Westlaw® databases or “more like this” in the Lexis/Nexis® databases). Again, the efficiency of the key word searching is highly dependent upon the user inputting the appropriate “key words”.

The above-referenced prior art research techniques require the use of referencing a table of contents, indexes, proprietary classification systems and/or key words to arrive at the user's desired search results. Such prior art techniques also fail to provide intuitive visually-orientated formats or user interfaces for initiating and optimizing the user's search. Accordingly, there is also a need in the art for an improved system for facilitating online research in comparison to the prior art.

### BRIEF SUMMARY OF THE INVENTION

According to one embodiment of the present invention, a research software tool for use with an online external resource comprises a flowchart graphic user interface configured to be displayed on an electronic display. The flowchart graphic user interface includes a graphically indicated first defined area. The flowchart graphic user interface further includes a text string displayable within the first defined area. The flowchart graphic user interface further includes a graphically indicated second defined area. The flowchart graphic user interface further includes a text string displayable within the second defined area, at least one of the text strings being user selectable. The flowchart graphic user interface further includes relationship symbology displayable between the first and second defined areas. The research software tool further comprises a user selectable link corresponding to at least one of the text strings. The user selectable link is an active link that is configured to interface with the online external resource, and that includes a search criterion related to at least one of the text strings, for use with the online external resource.

According to another embodiment of the present invention, an apparatus comprises a computer readable memory and program instructions stored in the computer readable memory. The program instructions are configured to display a flowchart graphic user interface that includes first and second graphically indicated defined areas. The program instructions are further configured to display a text string within at least one of the first and second graphically indicated defined areas. The program instructions are further configured to display relationship symbology between the first and second graphically indicated defined areas. The program instructions are further configured to provide a user selectable link corresponding to the text string. The user selectable link provides a search criterion to an online external resource. The program instructions are further configured to display information received from the online external resource in response to a user selecting the user selectable link.

According to another embodiment of the present invention, a graphic user interface is configured to be displayed on an electronic display and to be used to store electronic content. The graphic user interface comprises a graphically indicated first main folder. The graphic user interface further comprises a graphically indicated second main folder. The graphic user interface further comprises user defined relationship symbology displayable between the first and second main folders. The graphic user interface further comprises a user prompt configured to indicate to the user that the user is to select at least one of the graphically indicated main folders with which the electronic content is to be associated. The electronic content is represented as associated with the user-selected graphically indicated main folder.

According to another embodiment of the present invention, a graphic user interface system is configured to be displayed on an electronic display and to be used for representation of electronic content. The graphic user interface system comprises a plurality of graphic user main folders. The graphic user interface system further comprises user defined relationship symbology displayable between at least a first graphic user main folder and at least a second graphic user main folder. The graphic user interface system further comprises a user prompt configured to query a user to select at least one of the graphic user main folders having user defined relationship symbology displayed therebetween. The electronic content is represented as stored in the user-selected graphic user main folders.

According to another embodiment of the present invention, a computer system comprises a processing unit for use with an electronic display. The processing unit is configured to electronically communicate with the display for displaying an electronic file system graphic user interface for representation of electronic content. The graphic user interface includes a graphically indicated first main folder, a graphically indicated second main folder, and relationship symbology displayable between the first and second main folders. The electronic content is represented as storable in the first and second main folders. The processing unit is further configured, at least partly in response to a user access instruction, to prompt a user to select at least one of the graphically indicated main folders having relationship symbology displayed therebetween. Electronic content is represented as associated with the user-selected graphically indicated main folder.

According to another embodiment of the present invention, a graphic user interface comprises a first viewing pane configured to display a directory tree structure on an electronic display. The directory tree structure includes a plurality of first folders used to organize electronic content. The graphic user interface further comprises a second viewing pane configured to display a flowchart structure on the electronic display. The flowchart structure includes a plurality of second folders used to organize electronic content. The flowchart structure includes user defined relationship symbology positioned between at least two of the second folders. At least one of the second folders is used to organize at least a portion of the same electronic content as at least one of the first folders.

According to another embodiment of the present invention, code stored in computer readable memory is configured to generate a graphic user interface for representation of electronic content. The graphic user interface includes a graphically indicated first main folder, a graphically indicated second main folder, and relationship symbology displayable between the first and second main folders. Electronic content is represented as storable in at least one of the first and second main folders. The code is further configured to make the graphic user interface accessible from a plurality of application software programs at least partly in response to receiving a user save instruction. The user can graphically select at least one of the first and second main folders with which the user wants the electronic content to be associated with.

According to another embodiment of the present invention, a computer-implemented method for storing electronic content comprises receiving a first user-defined flowchart definition that includes a plurality of folders and relationship symbology connecting at least two of the plurality of folders. The plurality of folders are enabled to represent the storage of the electronic content. The method further comprises creating a directory tree structure based on the first user-defined flowchart definition. The directory tree structure includes a plurality of subdirectories that correspond to the plurality of folders. The subdirectories represent the storage of the electronic content.

### BRIEF DESCRIPTION OF THE DRAWINGS

Exemplary embodiments of the electronic content management system disclosed herein are illustrated in the accompanying drawings, which are for illustrative purposes only. The drawings comprise the following figures, in which like numerals indicate like parts.

FIG. 1 is a front view of a computer system with monitor in accordance with an aspect of the present invention.

FIG. 2 is an enlarged front view of the monitor of FIG. 1 displaying an illustrative graphic user interface and display window.

FIG. 3 is an enlarged view of the graphic user interface of FIG. 2 with a pop-up window of a main folder.

FIG. 4 is the enlarged view of the graphic user interface of FIG. 3 with a selection pop-up window.

FIG. 5 is the enlarged view of the graphic user interface of FIG. 4 with an additional main folder and a prompted pop-up window.

FIG. 6 is the enlarged view of the graphic user interface of FIG. 5 with the pop-up selection window and a relationship symbology pop-up window.

FIG. 7 is the enlarged view of the graphic user interface of FIG. 6 with selected relationship symbology associated with the additional main folder.

FIG. 8 is a symbolic plan view of a research software tool as shown in functional relation to an end user and online external resources in accordance with the present invention.

FIG. 9 is a plan view of a computer monitor displaying an illustrative flowchart graphic user interface and display window.

FIG. 10 is an enlarged view of a graphically indicated area of the display window of the flowchart graphic user interface of FIG. 9.

FIG. 11 is the graphically indicated area of FIG. 10 as additionally shown with a pop-up window.

FIG. 12 is a schematic illustration of an exemplary side-by-side view that includes a conventional directory tree structure and a graphic user interface with user-defined relationship symbology.

FIG. 13 is a schematic illustration of an exemplary multi-pane display that includes selected features disclosed herein.

### DETAILED DESCRIPTION OF PREFFERED EMBODIMENTS

Part A: Electronic File System Graphic User Interface Including User Defined Relationship Symbology Between Folders.

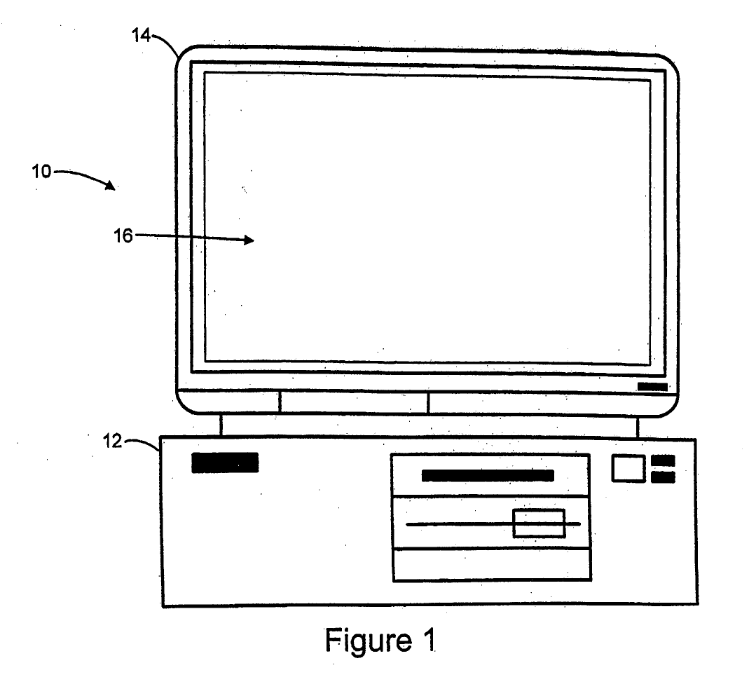

Referring now to the drawings wherein the showings are for purposes of illustrating preferred embodiments of the present invention only, and not for purposes of limiting the same, FIGS. 1 through 7 illustrate a research software tool in accordance with the aspects of the present invention.

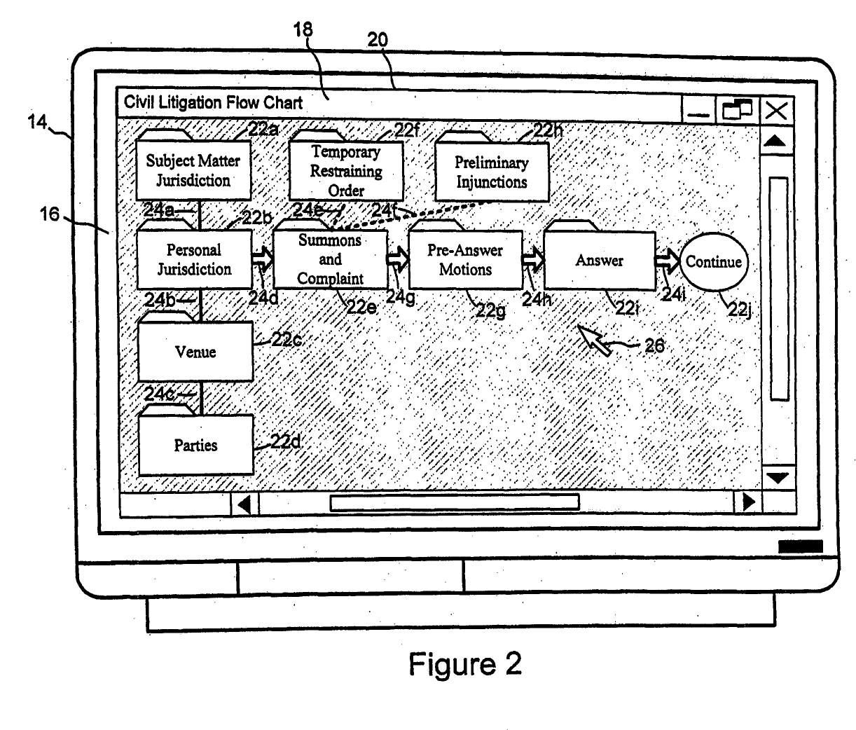

Referring now to FIG. 1, there is depicted a symbolic plan view of a computer system 10 in accordance with an aspect of the present invention. The computer system 10 includes a processing unit 12 and a monitor 14 with a screen 16. In this regard, FIG. 2 depicts an enlarged front view of the monitor 14 and screen 16. In the embodiment shown, displayed upon the screen 16 there is depicted an electronic file system graphic user interface 18 as it appears in a display window 20. In this example, the graphic user interface 18 is related to the topic of civil litigation and is labeled “Civil Litigation Flow Chart.” As shown, the graphic user interface 18 features a plurality of graphically indicated main folders 22a-j (each labeled with a sample topic related to civil litigation) and user defined relationship symbology 24a-i disposed between various ones of the main folders 22a-j as discussed in detail below. Preferably a user is allowed to interact with the graphic user interface 18 through controlled usage of a cursor 26. The cursor 26 may be moved to various portions of the display window 20.

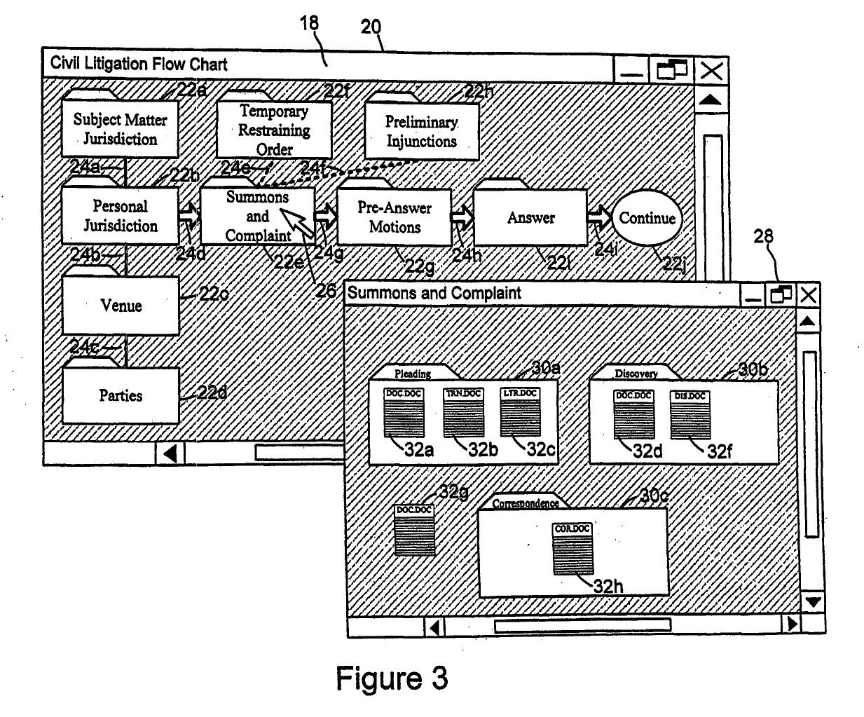

An aspect of the present invention can be regarded as the electronic file system graphic user interface 18 for representation of electronic files (such as electronic files 32a-h as seen in FIG. 3 discussed below). The graphic user interface 18 includes a graphically indicated first main folder (such as 22b), a graphically indicated second main folder (such as 22e), and user defined relationship symbology (24d) displayable between the first and second main folders 22b,e. The electronic files 32a-h are represented as storable in the first and second main folders 22b,e.

Referring now to FIG. 3 there is depicted the enlarged view of the graphic user interface 18 of FIG. 2 with a main folder window 28 of the main folder 22e labeled “Summons and Complaint.” In this regard, the main folder 22e may be “clickable” so as to initiate the opening of the main folder window 28 with the use of the cursor 26 positioned over the main folder 22 as shown. The main folder window 28 includes subfolders 30a-c. The electronic files 32a-c are shown as being disposed within the subfolder 30a, the electronic files 32d,f are shown as being disposed within the subfolder 30b, and the electronic file 32h is shown as being disposed within the subfolder 30c. The electronic file 32g is shown as being disposed simply within the main folder window 28.

The graphic user interface 18 optionally includes folders which are hierarchical in nature. Specifically, one or more of the folders 22a-22i optionally includes a “sub-hierarchy” of folders which is expandable to form part of the larger graphic user interface 18. For instance, in the exemplary embodiment illustrated FIG. 2, folder 22b (Personal Jurisdiction) optionally includes a sub-hierarchy of subfolders containing topics such as minimum contacts and traditional basis. The sub-hierarchy of folders is viewed in a similar way as the main folder window 28 is viewed, as described above. The subfolders optionally contain further sub-hierarchies. The flowchart graphic user interface 18 is configurable to show all sub-hierarchies or selected sub-hierarchies, optionally based on a particular user's preference and specification, and/or optionally based on the number and/or complexity of the sub-hierarchies.

Advantageously, the graphic user interface 18 enables a user to understand the electronic filing system in a visually intuitive manner. This is because the graphic user interface 18 utilizes the relationship symbology 24 between main folders 22 which allows the electronic files 32 to be stored and accessed in a flowchart format. The relative positioning of the various ones of the main folders 22 upon the display window 20 aid in the understanding of an end user of the various relationships between the main folders 22. In addition, the relationship symbology 24 further conveys information to the end user regarding the relationship between the main folders 22. The relative locations, types, and orientations of the main folders 22 and the relationship symbology 24 may all be utilized to convey information to the end user.

The electronic files 32 may be any storable file that may be electronically saved and retrieved. The various formats for such electronic files 32 may vary. For example, the electronic files 32 may be word processing documents, spreadsheet files, scanned documents, image documents, e-mails, and so forth.

It is contemplated that the electronic files 32 can be co-indexed, synchronized or otherwise associated with other well known electronic document management programs (for example, DocsOpen and IManage), so users do not have to abandon and/or can concurrently use other document management programs. The electronic files 32 need not be stored at the same location as the software responsible for generating the graphic user interface 18. The electronic files 32 may be stored and accessed from one or many places including but not limited to the user's own computer, central server or online storage (which could be made available through an online application service provider (“ASP”) version of the software product responsible for generating the graphic user interface 18.

As used herein the term “main folder” refers to an electronic folder capable of containing an electronic file or subfolder. A main folder may itself be a subfolder. However, it is important to note that a given main folder cannot be linked through user defined relationship symbology to another main folder that is contained within such given main folder. Thus, by definition, a given main folder could not be linked to its own subfolder using the user defined relationship symbology.

The topical scope of the graphic user interface 18 may be unlimited. The example shown is related to civil procedure. Other sample topics or processes that lend themselves to presentation in a flowchart format for storing related electronic files may include, but are not limited to, specific issues in civil litigation such as discovery; evidence; criminal procedure; wage and labor law; constitutional law; appellate law; class actions; specific types of litigation (such a sexual and/or racial harassment lawsuits); contracting; corporate formation; mergers and acquisitions; securing protection of intellectual property; initial public offerings; private offerings; real estate purchase and sale agreements; buying and/or selling a home; basic home repair; traveling in a particular city or country; personal income taxes; trading stocks and other securities; developing photographs; buying and/or selling a franchise; schematics of the world's religions; asset allocation strategies; schematic of a space shuttle launch; diagnoses of a disease based on symptoms; fixing a television; adding memory to a personal computer or laptop; tune-up procedures for a vehicle; and specific vehicle repairs.

As mentioned above, in this example the graphic user interface 18 is related to the topic of civil litigation, and could be helpful to an end user or group of end users who are involved with a particular litigation, such as those in a law firm for example. The graphic user interface 18 facilitates the filing of the electronic files 32 in the context of the process of civil litigation. In this regard, by quickly scanning the graphic user interface 18 the end user is contemplated to understand that the electronic files related to “subject matter,” “personal jurisdiction”, “venue,” and “parties” (as indicated in the main folders 22a-d) are sequentially addressed prior to completion of the issue of “summons and complaint” (as indicated by the main folder 22e). Furthermore, the portion of the litigation process associated with the “summons and complaint” must be completed prior to moving on to the topic of “pre-answer motions” (as indicated in the main folder 22g). As such, a user that may not be familiar with the particular computer system of a given organization could interact with the graphic user interface 18 and intuitively access desired electronic files 32. This is because such electronic files 32 are stored in a manner which is more universally understood, that is, the associated process. For example, a newly assigned attorney who begins work in an ongoing lawsuit handled by a law firm could intuitively find, store, and access electronic files 32 by simply seeing the litigation process in the graphic user interface 18. In this regard, all electronic files 32 related to the issues of the “Answer” would be expected to be found somewhere within the main folder 22i which is so labeled.

As such, the graphic user interface 18 is intended to provide the end user with a visual organization of data, including relationships between various items of data (such as chronological, sequential or organizational relationships). These may be temporal as well as event based. This is in contrast to a typical electronic filing system that presents electronic files as being stored in a series of folders and subfolders which are arranged merely in an alphabetical manner or by date for example. While “window” type of electronic folders are known and may be positioned and disposed relative to each other in a “flowchart” manner (such as a directory tree structure), the present graphic user interface 18 is distinctive with the implementation of the user defined relationship symbology 24 as discussed further below.

Although the computer system 10 is depicted as being a personal computer, other configurations may be utilized. For example, the processing unit 12 may take the form of a processing unit of a laptop or a network server. In addition, it is contemplated that the functionality of the graphic user interface 18 may be programmed by any of those software techniques which are well known to one of ordinary skill in the art.

In further detail, the main folders 22 may take a variety of forms. In the example shown, the main folders 22 are indicated by a symbolic graphic of a physical folder. Other shapes may be utilized. Although the perimeter lining is shown as being black solid lined, any other lining may be utilized such as dotted or dashed, as well as various line thicknesses and colors (including clear).

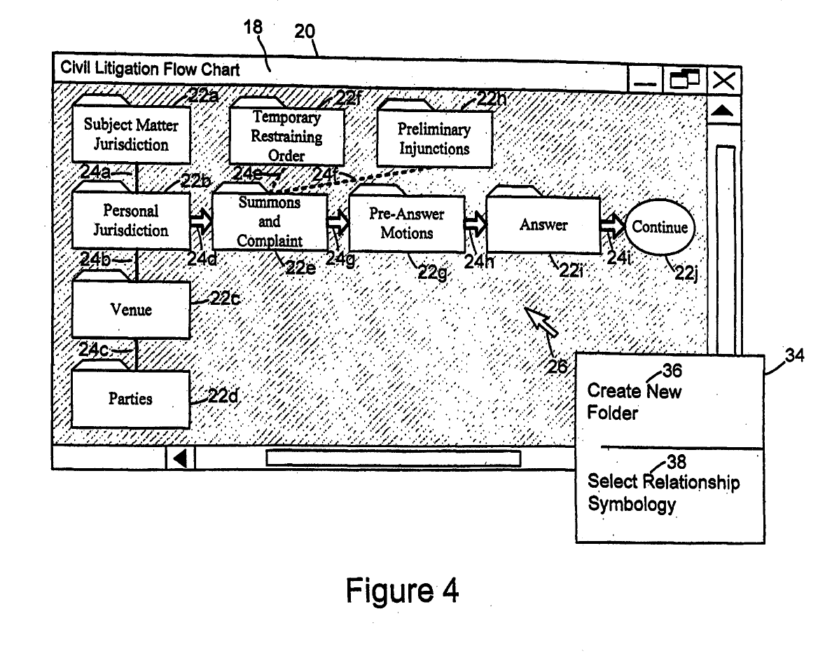

Referring now to FIGS. 4 through 7 there is depicted a sample sequence in the use of the graphic user interface 18 to create a new main folder. FIG. 4 depicts the enlarged view of the graphic user interface 18 of FIG. 3 with the cursor 26 repositioned to an open space of the display window 20.

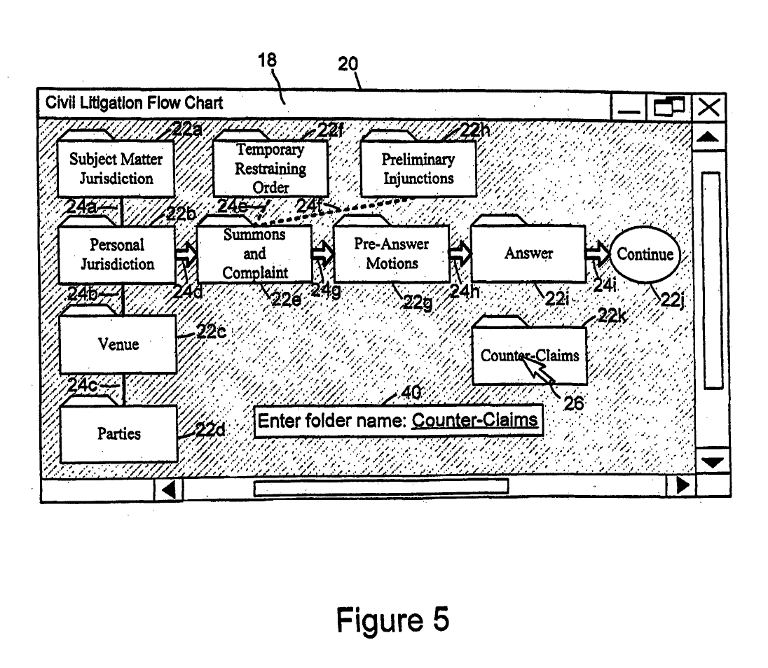

The graphic user interface 18 may be programmed to allow for pull-down menus or pop-up windows to be used for selection of various desired tasks. For example, “right clicking” of a user's computer mouse may result in a selection popup window 34 such as shown. In this example, the user may move the cursor 26 to the Create New Folder selection 36 of the selection popup window 34 and select it by “left clicking” the computer mouse. As shown in FIG. 5 after making such selection, a new main folder 22k is created at such location of the display window 20. The user may be prompted to associate a name or label with the main folder 22k as facilitated by a prompted popup window 40. In this case, the user is shown to have entered “Counter-Claims” as the name of the main folder 22k. Though not shown, it is contemplated that the user may also select a “Show Relationships” selection from the prompted popup window 40. All symbology from the main folder would be demarked in a manner which would make them standout from others, and thus explicitly stating the relationships between main folder and subfolders. Thus all relationships which originate from a particular folder may be highlighted. Such as highlighting could be restricted to show only forward or reverse directional relationships for example.

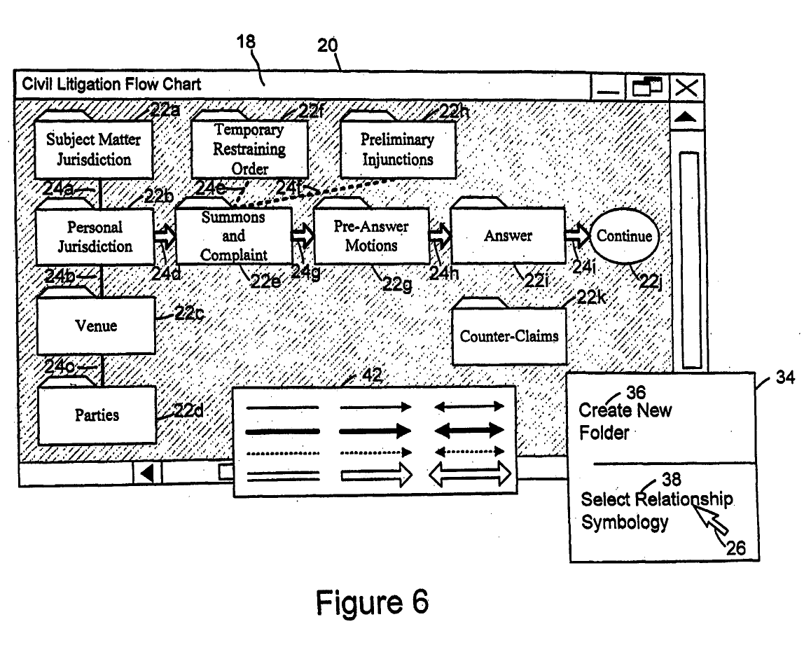

FIG. 6 is the enlarged view of the graphic user interface of FIG. 5. As can be seen, the cursor 26 is relatively moved down and to the right, and the computer mouse is presumed to have been right clicked so as to initiate the selection popup window 34. The selection popup window 34 further includes a Select Relationship Symbology selection 38. Left clicking of the computer mouse with the cursor 26 over the Section Relationship Symbology section 38 initiates the relationship symbology popup window 42. As shown for example, the relationship symbology popup window 42 contains various relationship symbology types that may be selected (including solid lines, thick solid lines, dashed lines and double lines, and all of which may include no arrow heads, or single arrow heads and double arrow heads).

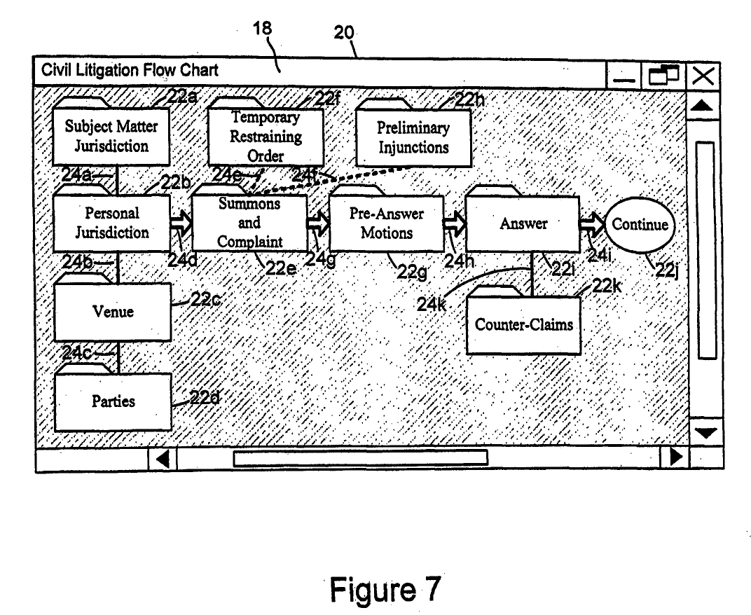

In this example, the user is contemplated to have chosen the simple solid line with no arrow heads. Further, the user is contemplated to have clicked both the main window 22i and the main window 22k. As seen in FIG. 7, this results in the creation of the user defined relationship symbology 24k disposed between the main folders 22i,k. As such, the user is contemplated to exercise control over the type of relationship symbology 24 displayed. In this regard, as used herein the term “user defined” refers to the ability of the user to interface with the graphic user interface 18 so as to exercise some degree of control in the selection of the relationship symbology 24 between main folders 22. Though not shown, the relationship symbology 24 may also be indicated in a variety of ways, including variances of shape, lining, background and/or color.

Another aspect of the invention is a software program that enables the user to create the graphic user interface 18, and/or modify an existing graphic user interface to thereby create the graphic user interface 18. Thus, a user may be able to customize the graphic user interface 18 to his/her own particular requirements or preferences. In this regard, this process may be conceptualized as an end user creating a database, such as in Microsoft Access, using a Microsoft Visio-type visual interface. Such software could be configured with the end user with a few pre-existing graphic user interfaces 18 (such as specifically tailored to different topic such as personal finance, tracking/planning of a child's future for examples) into which an end user can file electronic files.

Additional modifications and improvements of the present invention may also be apparent to those of ordinary skill in the art. Thus, the particular combination of parts described and illustrated herein is intended to represent only one embodiment of the present invention, and is not intended to serve as limitations of alternative devices within the spirit and scope of the invention.

Part B: Research Software Tool with Flowchart Graphic User Interface.

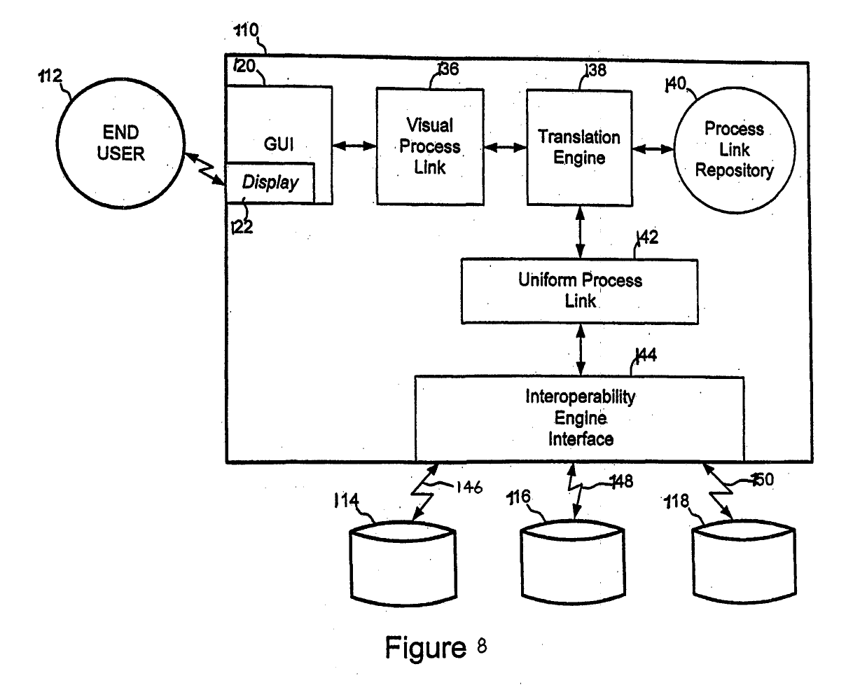

FIGS. 8 through 11 illustrate a research software tool in accordance with the aspects of the present invention.

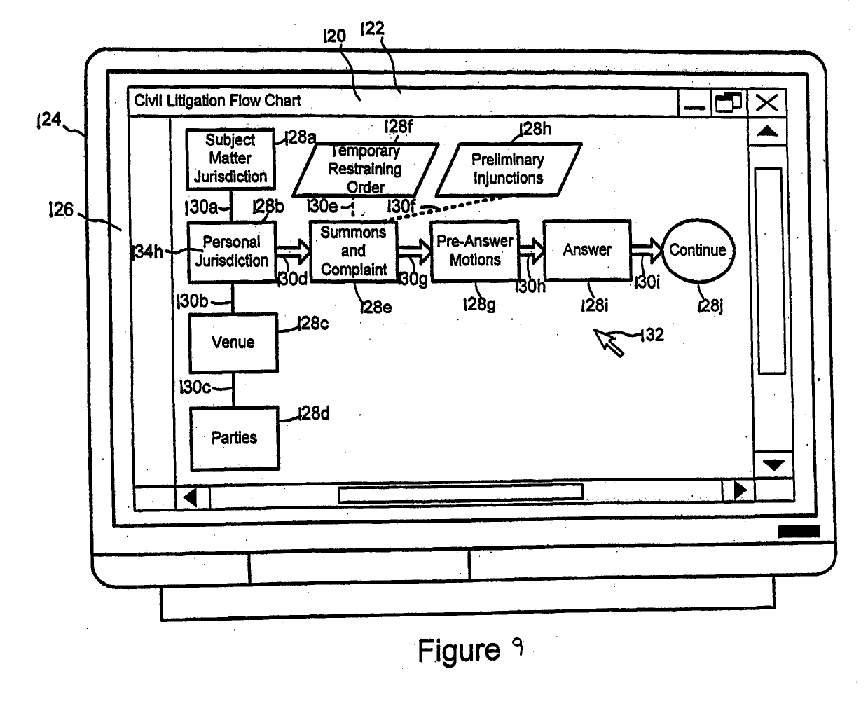

Referring now to FIG. 8, there is depicted a symbolic plan view of a research software tool 110 as shown in functional relation to an end user 112 and online external resources 114, 116, 118 in accordance with the present invention. The research software tool 110 includes a flowchart graphic user interface 120 including a display 122. In this regard, FIG. 9 depicts a plan view of a computer monitor 124. The computer monitor 124 includes a display field 126. In this particular embodiment, the flowchart graphic user interface 120 including its display 122 appears in the display field 126. Though not required, the display 122 takes the form of a “window” in this particular embodiment.

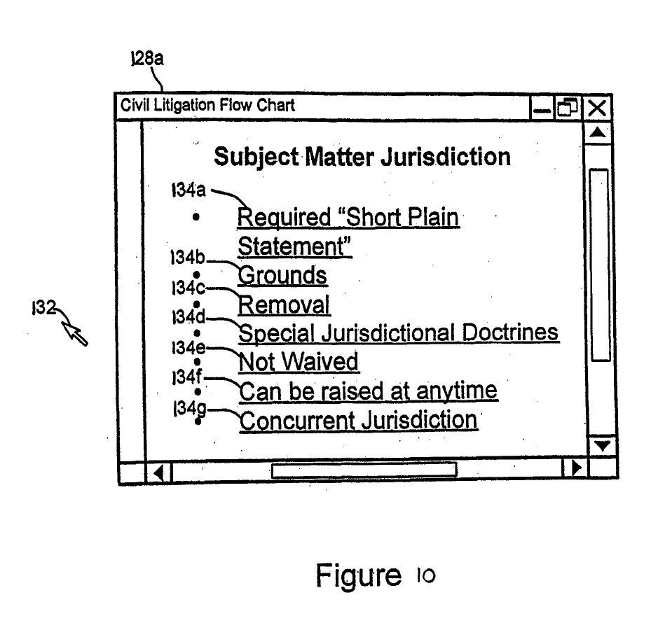

The flowchart graphic user interface 120 of this embodiment includes graphically indicated defined areas 128a-j. An enlarged view of the graphically indicated defined area 128a is shown in FIG. 10. In this regard, details of contents of each of the graphically indicated defined areas 128a-j are not shown in FIG. 9 for ease of illustration. The flowchart graphic user interface 120 of this embodiment further includes relationship symbology 130a-i interposed between various ones of the graphically indicated defined areas 128a-j. As seen in FIG. 10, the graphically indicated defined area 128a includes text strings 134a-h. In this example, the flowchart graphic user interface 120 is related to the topic of civil litigation.

An aspect of the present invention can be regarded as the research software tool 110 for use with an online external resource, such as the online external resource 114. The research software tool 110 includes the flowchart graphic user interface 120. The flowchart graphic user interface 120 includes a graphically indicated first defined area (such as graphically indicated defined area 128a) and a text string (such as text string 134b) displayable within the graphically indicated defined area 128a. The flowchart graphic user interface 120 further includes a graphically indicated second defined area (such as graphically indicated defined area 128b), and a text string (such as text string 134h) displayable within the graphically indicated defined area 128b. At least one of the text strings 134b, 134h is user selectable. The flowchart graphic user interface 120 further includes relationship symbology (such as relationship symbology 130a) displayable between the graphically indicated defined areas 128a-b. The research software tool 110 further includes a user selectable link 146 corresponding to the at least one of the text strings, such as text string 134b. The user selectable link 146 is configured to interface with the online external resource 114.

Being a “flowchart” the flowchart graphic user interface 120 is intended to provide the end user 112 with a visual organization of data, including relationships between various items of data (such as chronological, sequential or organizational relationships). These may be temporal as well as event based. As mentioned above, in this example the flowchart graphic user interface 120 is related to the topic of civil litigation, and would be intended to be helpful to an end user 112 who is a litigator. The flowchart graphic user interface 120 presents data related to the process of civil litigation. In this regard, by quickly scanning the flowchart graphic user interface 120 the end user 112 is contemplated to understand that the issues related to “subject matter,” “personal jurisdiction”, “venue,” and “parties” (as indicated in the graphically indicated defined areas 128a-d) all must be addressed prior to completion of the issue of “summons and complaint” (as indicated in the graphically indicated defined area 128e). Furthermore, the portion of the litigation process associated with the “summons and complaint” must be completed prior to moving on to the topic of “pre-answer motions” (as indicated in the graphically indicated defined area 128g).

The relative positioning of the various ones of the graphically indicated defined areas 128a-j upon the display 122 aid in the understanding of the end user 112 of the various relationships. In addition, the relationship symbology further conveys information to the end user 112 regarding the relationship between the graphically indicated defined areas 128a-j. The relative locations of the graphically indicated defined areas 128a-d, 128e and the relationship symbology 130a-d are intended to convey to the end user 112 that the issues associated with the graphically indicated defined areas 128a-d are addressed prior to those issues of the graphically indicated defined area 128e.

The topical scope of the flowchart graphic user interface 120 may be unlimited. The example shown is related to civil procedure. Other sample topics or processes that lend themselves to presentation in a flowchart format may include, but are not limited to, specific issues in civil litigation such as discovery; evidence; criminal procedure; wage and labor law; constitutional law; appellate law; class actions; specific types of litigation (such a sexual and/or racial harassment lawsuits); contracting; corporate formation; mergers and acquisitions; securing protection of intellectual property; initial public offerings; private offerings; real estate purchase and sale agreements; buying and/or selling a home; basic home repair; traveling in a particular city or country; personal income taxes; trading stocks and other securities; developing photographs; buying and/or selling a franchise; schematics of the world's religions; asset allocation strategies; schematic of a space shuttle launch; diagnoses of a disease based on symptoms; fixing a television; adding memory to a personal computer or laptop; tune-up procedures for a vehicle; and specific vehicle repairs.

As mentioned above, the research software tool 110 includes the user selectable link 146 corresponding to the at least one of the text strings, such as text string 134b, and the user selectable link 146 is configured to interface with the online external resource 114. In this regard, the research software tool 110 is contemplated to facilitate ready access by the end user 112 to content contained in the online external resource 114. It is contemplated that the end user 112 is enabled to navigate to such external content in a visually intuitive manner as navigation is guided in the context of a flowchart format. When performing a research task, the flow chart presentation of the various graphically indicated defined areas 128a-j efficiently allows the end user 112 to locate external content associated with a given graphically indicated defined area 128a-j. This is in contrast to accessing results (for example, case opinions, statutes, and relevant sections of secondary materials in the context of a civil litigation flowchart) through a typical chapter/page presentation such as in the case of an electronic version of a treatise on the topic of interest. The end user 112 does not need to analyze any table of contents or index. This is also in contrast to accessing results through key word searching where the end user 112 is required to identify the appropriate key words. Further, it is contemplated that the flowchart presentation allows the end user 112 to identify issues quickly because the end user 112 is allowed to see the overall context in which the issues are being presented.

In further detail, the graphically indicated defined areas 128a-j may take a variety of forms. In the example shown, the graphically indicated defined areas 128a-d, 128e, 128g, 128i are indicated by solid lined rectangles, the graphically indicated defined areas 128f, 128h are indicated by solid lined trapezoids, and the graphically indicated defined area 128j is indicated with a solid lined oval. Other shapes may be utilized. Although the perimeter lining is shown as being black solid lined, any other lining may be utilized such as dotted or dashed, as well as various line thicknesses and colors (including clear). The graphically indicated defined areas 128a-j are shown with a clear background. However, the background coloring, pattern and shading also may be varied. The various forms of the graphically indicated defined areas 128a-j may be used to provide the end user 112 with information which may be spelled out in a legend for example. For example, trapezoid shapes may used to indicate optional items, such as indicated by the graphically indicated defined areas 128f, 128h. The relationship symbology 130a-i may also be indicated in a variety of ways, including variances of shape, lining, background and/or color.

Preferably the end user 112 is allowed to interact with the graphically indicated defined areas 128a-j through controlled usage of a cursor 132. The cursor 132 may be moved to various portions of the display 122. For example, FIG. 10 depicts the graphically indicated defined area 128a with its associated text strings 134a-g (it is noted that FIG. 9 does not include the detail of the text strings 134 a-g of the defined areas 128a for ease of illustration). The defined area 128a is related to the topic of “subject matter.” The end user 112 may move the cursor 132 to a selected one of the text strings 134a-g.

According to various embodiments, the at least one of the text strings 134a-h may be clickable. Thus, selected ones of the text strings 134a-h may be associated with a user selectable link 142. The text string 34a may be selected by navigating the cursor over the text string 34a and clicking on it. This may initiate the establishment of the user selectable link 146 which may be configured to link with the online external resource 114. In the embodiment illustrated in FIG. 8, the user selectable link is a uniform process link 142.

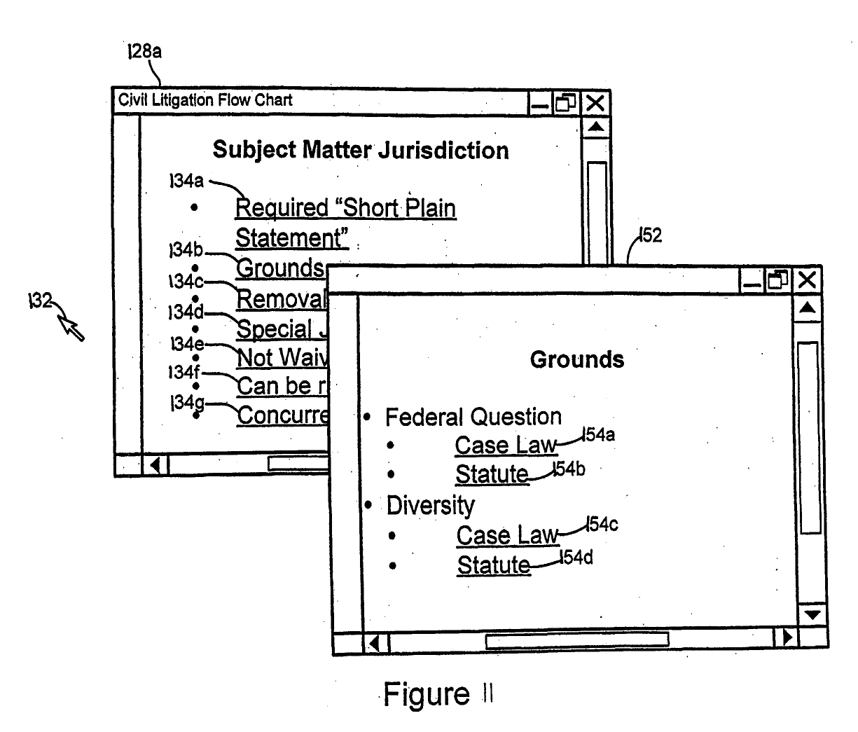

The text strings, such as text string 134b may include a displayable menu 152 that includes the uniform process link 142. In this example, the end user 112 may navigate the cursor 132 to the text string 134b and then click the text string 134b as depicted in FIG. 11. The menu 152 is embodied in a popup window and may further include text strings 154a-d. Menu 152 may also be embodied in a transitionary, temporary, or popup window or other graphically defined area that is displayed and contains text strings 154a-d as the user moves the cursor 132 over the text string 134b, but does not click on it. Clicking on the text string 154a for example may initiate the uniform process link 146 for accessing data from a selected online external resource 114.

The online external resources 114, 116, 118, may take the form of computer servers containing databases of content. The online external resources 114, 116, 118 may be operated by private, charitable and governmental entities. The online external resources 114, 116, 118 may be freely accessed (for example, www.google.com) or proprietary in nature requiring a fee (for example, www.westlaw.com). Access to the online external resources 114, 116, 118 may be via the Internet and through an associated website. In this regard, the user selectable link 142 may be configured to interface with the online external resources 114, 116, 118 via the Internet. The online external resources 114, 116, 118 may be specific database structures within a grouping of databases (for example the Westlaw® “ALLFEDS” database). In the context of the online external resources 114, 116, 118, the term external refers to being separate from a computer device operated or accessed directly by the end user 112. Thus, the research software tool 110 would reside on a computing device remote from a location of the online external resources 114, 116, 118 in terms of physical proximity, security, management or control authority. Thus, the online external resources 114, 116, 118 may be accessed via a website that may be coincidentally co-located with a host computing system as where the research software tool 110 resides. In one embodiment, the online external resource is provided on a portable medium, such as a compact disc, that can be accessed using a reader that is provided locally or remotely to the end user's computer.

The uniform process link 142 may be an active link for electronically linking with a given one of the online external resources 114, 116, 118. In this regard, clicking on a given text string may result in retrieval of a specific webpage of a given one of the online external online resources 114, 116, 118. Thus data from discrete or rigid data structures may be retrieved. For example, clicking on the text string 154b “statute” may retrieve a webpage that contains a relevant “statute” related to the topic of “subject matter jurisdiction” based upon “grounds” of a “federal question.” Another example may include the retrieval of the Costa Rican consulate website that allows a user to click on a text string entitled “obtaining visas before travel” in the context of a flowchart related to travel to Costa Rica.

In another arrangement, the uniform process link 142 may be a passive link for electronically linking with selected ones of the online external resource 114, 116, 118. The uniform process link 142 may include predefined search criteria for use with the online external resources 114, 116, 118. In this regard, the uniform process link 142 may include pre-loaded search terms for use in retrieving content contained in the online external resources 114, 116, 118. This may take the form of pre-conditions for access retrieval, parameters such as for a Boolean search, and post-conditions (such as date ranges or particular value types). For example, in the Costa Rican travel flowchart example, a user may select the “obtaining visa before travel” text string and be presented immediately with a list of search results (for example, a variety of websites relevant to obtaining visas before traveling to Costa Rica) derived from applying the pre-loaded search criteria to an Internet search engine. In this context, an example of a post-condition would be only presenting the user with those results that contain webpages updated within the past year.

In an example configuration, the research software tool 110 includes the flowchart graphic user interface 120 that may be configured to interface with a visual process link 136. The visual process link 136 is programmed to correlate to various ones of the text strings 134a-g that are to be actively linked. Active links refers to a linking process which is non-discrete or non-determinant in nature. The visual process link 136 interfaces with a translation engine 138. The translation engine 138 extracts data from a process link repository 140. The process link repository 140 contains expressions for mapping of visual process link data to uniform process link data. The translation engine 138 interfaces with uniform process link 142. This step is taken to provide a linguistically normalized expression to the interoperability engine. The uniform process link 142 interfaces with an interoperability engine interface 144. The interoperability engine interface 144 contains programming which enables the uniform process link 142 to establish a connection with selected ones of the online external resources 114, 116, 118. This would include any necessary computer addressing to navigate to the external resources 114, 116, 118 such as login identification and passwords (if necessary) and specifying a data repository within a given one of the online external resources 114, 116, 118. Finally, the research software tool 110 may be configured to establish user selectable links 146, 148, 150 to the various external online resources 114, 116, 118. Such links 146, 148, 150 may be established by any of those electrical communications methods which are well known to one of ordinary still in the art.

The uniform resource link 142 may be configured to interface with a selected one of the online external resources 114, 116, 118 that may be located and retrieved through a search engine program. Select key words may be pre-loaded and associated with a given one of the graphically indicated defined areas 128a-j (such as the graphically indicated defined area 128b) and the related text string (such as text sting 134h). For example, clicking on the text string 134b may initiate a search on a search engine utilizing the key terms “grounds,” “subject matter jurisdiction,” and “civil litigation.” Thus, the end user 112 may be able to perform quickly a search.

Additional modifications and improvements of the present invention may also be apparent to those of ordinary skill in the art. Thus, the particular combination of parts described and illustrated herein is intended to represent only one embodiment of the present invention, and is not intended to serve as limitations of alternative devices within the spirit and scope of the invention.

Part C: Flowchart-Based Electronic Content Management System

As described herein, in certain embodiments a graphical hierarchy of folders is used to represent a system for storing electronic content. For example, FIG. 2 illustrates a flowchart graphic user interface 18 in which a plurality of folders 22a-j each relate to a particular topic in the context of civil litigation. The plurality of folders 22a-j are optionally linked to each other using user defined relationship symbology 24a-i. The folders 22a-j are arranged so as to graphically illustrate a method or a process, such as in a flowchart-type arrangement. Optionally, feedback or loop back symbology (for example, an arrowed line indicating that a process from a given state proceeds to a previously performed state) is provided. Optionally, the user can select the colors for each flowchart “block” (for example, a folder/state) to further ease quick identification of a desired flowchart file or state. For example, optional states (folders) that relate to client interactions can be in one color, while states (folders) that relate to court interactions can be in another color. Other displayable properties of the folders—such as shape, size, line weight, font, blinking, and animation—can be specified or modifiable by a user are also modifiable to provide additional information to one or more users. Such embodiments advantageously provide the user with the flexibility to arrange the folders in a graphical layout other than a conventional directory tree structure, thereby providing the user with a more intuitive organizational system for storing electronic content and providing the user with guidance with respect to performing actions corresponding to the flowcharted process.

For example, a user who is familiar with the civil litigation process will be able to locate electronic content more quickly using the flowchart-based graphic user interface 18 illustrated in FIG. 2, as compared to a conventional directory tree structure. The flowchart graphic user interface 18 also advantageously provides the user with information about the method or process that is not provided by a conventional directory tree structure. For example, a conventional directory tree structure does not provide ordering information, such as which process step occurs first, second, and third, which activities are more significant (for example, as might be represented a certain color, a certain size, and/or a certain type of animation, such as a file representation that vibrates), and so forth.

Still referring to FIG. 2, the flowchart-based graphic user interface 18 optionally includes folders which are hierarchical in nature. Specifically, one or more of the folders 22a-22i optionally includes a “sub-hierarchy” of folders which is expandable to form part of the larger flowchart-based graphic user interface 18. For instance, in the exemplary embodiment illustrated FIG. 2, folder 22b (Personal Jurisdiction) optionally includes a sub-hierarchy of subfolders containing topics such as minimum contacts and traditional basis. Likewise, each one of these subfolders optionally contains further sub-hierarchies. The flowchart graphic user interface 18 is configurable to show all sub-hierarchies or selected sub-hierarchies, optionally based on a particular user's preference and specification, and/or optionally based on the number and/or complexity of the sub-hierarchies.

In an exemplary embodiment, a graphic user interface, such as the exemplary flowchart graphic user interface 18 illustrated in FIG. 2, is optionally integrated with a conventional electronic content management system, although integration with new or unconventional systems is provided for herein. Examples of electronic content management systems include iManage and DocsOpen; such systems are configured to manage a wide variety of electronic content, including files containing text, graphics, multimedia, other data, and a combination thereof. When a user accesses content stored in the electronic content management system in such example embodiments, the user is presented with the flowchart-type graphic user interface instead of, or in addition to a conventional directory tree structure. As used herein, “accessing content” includes activities such as opening documents, viewing documents, sending documents and saving documents. Content is accessed using a wide variety of application software, such as word processors, databases, email clients, web browsers, and spreadsheet programs.

In an exemplary embodiment, this is accomplished by receiving a “Save” command from the user, and subsequently presenting the user with a flowchart-based graphic user interface from which the user can select one or more folders to which the electronic content is to be associated. Optionally, the “Save” command is available in a wide variety of application software, including word processors, electronic content managers, desktop publishers, databases, email clients, and web browsers. Optionally, in one embodiment data, from an electronic content manager, such as metadata associated with a particular file, is used to automatically select which folder or folders in which a particular item of electronic content should be represented as stored.

In another embodiment, when a user invokes a “Save” command from an application such as an electronic content manager, a word processor or an email client, a dialog box or other indicator appears prompting the user to select one or more locations where the electronic content should be represented as being stored. For example, in one configuration this involves presenting the user with a conventional directory tree structure and prompting the user to select one or more of the folders included therein. Optionally, this alternatively or additionally includes presenting the user with a flowchart graphic user interface and prompting the user to select one or more of the folders included therein in which the content is to be stored (for example, organizationally represented). This also optionally includes populating a database relating to the electronic content based on the user-selected folder or folders. For example, in certain embodiments the user's folder selection provides information about the electronic content being saved, such as client and matter information, which is saved in an electronic content management database.

In one embodiment, a standard graphic user interface flowchart structure is created for new matters to be added to the electronic content management system. The standard graphic user interface flowchart structure optionally includes a plurality of commonly-used folders for a particular topic. For instance, the example graphic user interface 18 illustrated in FIG. 2 contains a flowchart structure that is particularly useful in the context of a civil litigation process; other graphic user interfaces are customized for other processes, examples of which include a patent prosecution process, an immigration process, and a mortgage application process. Other processes are used in other embodiments. In one embodiment, when a user creates a new graphic user interface flowchart structure for a particular matter, the user is prompted to select a topic to which the new matter relates or to select a desired template from a library of listed and/or displayed flowchart templates. For example, a standard graphic user interface flowchart structure is then generated/presented based on the user-selected topic or template.

In one embodiment, the standard graphic user interface flowchart structure includes appropriately-named folders based on the user-selected topic. Optionally, the user is enabled to subsequently edit and/or modify the standard graphic user interface flowchart structure, for example by adding folders, deleting folders and/or renaming folders.

In one embodiment, users are granted permission from an administrator to create additional folders and/or to modify the relationship symbology between folders, which in other embodiments the folders and the relationship symbology are not modifiable. The permission may be recorded in a database in association with user identification information (for example, a user password, a user identification, a code associated with a user computer, and so forth). For example, in one configuration users are selectively granted permission from an administrator to access and/or modify content stored in a particular folder. For example, if a user attempts to modify or access content or a flowchart, one embodiment determines if the user is authorized to do so, and if not, the user is so informed and access or the ability to modify is denied. Users are also optionally allowed to designate certain folders as “private” folders, thereby restricting access to such folders to selected other users, or to no other users.

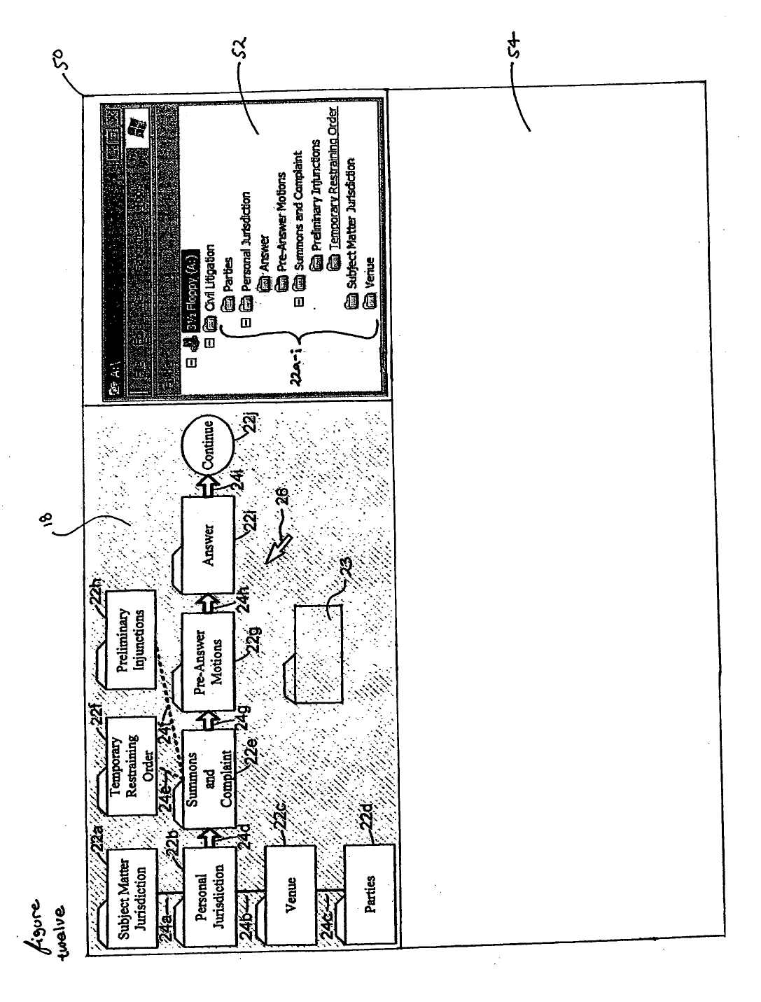

In embodiments wherein users are granted permission to add folders to the flowchart graphic user interface 18, the new folders optionally correspond to a folder in a conventional directory tree structure. FIG. 12 illustrates an exemplary embodiment of a side-by-side display 50 that includes a flowchart graphic user interface 18 with relationship symbology 24a-i, as well as a conventional directory tree structure 52. Use of a side-by-side display 50 is optional, and in certain modified embodiments a display is provided that shows only the flowchart graphic user interface 18, while in other modified embodiments a display is provided that shows only the conventional directory tree structure 52. In an exemplary embodiment, individual users control which display or displays are provided (for example, by instructing the system via a preferences specification interface or via a menu).

In an exemplary embodiment, adding a folder to the flowchart graphic user interface 18 automatically causes a corresponding folder to be added to the conventional directory tree structure 52, with the corresponding linking information stored in computer readable memory. Adding a new folder to the flowchart graphic user interface 18 includes moving and copying an existing folder to a new location. In one embodiment, the user is prompted to select a location for the newly added folder in the conventional directory tree structure 52, while in other embodiments the folder location is selected automatically. The conventional directory tree structure is accessible using a wide variety of applications, including common desktop applications such as email clients and word processors. Therefore, in such embodiments, using the flowchart graphic user interface to add a new folder also enables the new folder to be accessed using such other application programs.

Automatic selection of the folder location is optionally based on one or more parameters, such as the adjacency of folders in the flowchart graphic user interface 18, folder characteristics, and/or the relationship symbology, if any, associated with the new folder. For example, in an embodiment wherein the new folder is associated with an existing folder by a dotted line, (such as relationship symbology 24f that connects the “Summons and Complaint” folder 22e to the “Temporary Restraining Order” folder 22f illustrated in FIG. 12), the new folder is added as a subfolder of the existing folder in the conventional directory tree structure 52 (such as illustrated in FIG. 12). In one configuration, no relationship symbology is provided for the new folder, such that the new folder is not connected to other folders in the flowchart graphic user interface; an example of such a folder is indicated by folder 23 illustrated in FIG. 12. Such an “unconnected” folder is optionally omitted from the corresponding conventional directory tree structure 52.

Likewise, adding a folder to the conventional directory tree structure 52 causes a corresponding folder to be added to the flowchart graphic user interface 18, with the corresponding linking information stored in computer readable memory. Adding a new folder to the conventional directory tree structure 52 includes moving and copying an existing folder to a new location. In this example, the user is optionally prompted to provide information regarding the location of the added folder in relation to other existing folders in the graphic user interface. In another example embodiment, the system places the new folder at an appropriate location in the flowchart graphic user interface 18 based on the location of the new folder in the conventional directory tree structure. For example, addition of the “Temporary Restraining Order” subfolder as a subdirectory of the “Summons and Complaint” directory illustrated in the conventional directory tree structure causes the generation of the “Temporary Restraining Order” folder 22f that has relationship symbology 22e indicating a relationship with the “Summons and Complaint” folder 22e. Optionally, the user is prompted to verify the placement of the new folder in the flowchart graphic user interface 18 and/or the configuration of the new relationship symbology in the flowchart graphic user interface 18.

The flowchart graphic user interface is configurable to be accessible to several users, such as a group of users working on a particular matter to which the graphic user interface flowchart relates. This advantageously allows one user to access electronic content, including new folders, generated by other users. In addition, different users working on the same matter optionally use a common representation of the matter process flow via the flowchart, thereby enhancing efficiency and expediting user training.

Furthermore, the graphic user interface flowchart is optionally accessible from a wide variety of different applications. For example, the graphic user interface flowchart is accessible not only from a user's desktop, but also other applications, such as an email client, a word processor, a desktop publisher, a spreadsheet, a database manager, or a web browser. Thus, as described above, electronic content can be accessed from, and stored via a wide variety of different applications using the graphic user interface flowchart. For example, in one embodiment a user is able to view the flowchart graphic user interface and electronic content stored therein using an email client.

Likewise, the flowchart graphic user interface is storable in a wide variety of locations on a computer file system. In one embodiment, the flowchart graphic user interface is stored in a network-accessible location, thereby providing access to a large number of users. In another embodiment, the user is prompted to indicate a location where the files represented by the flowchart graphic user interface are saved, such as in a “My Documents” folder or a subfolder thereof.

In a modified embodiment, the side-by-side display is presented in a display pane that forms part of a larger composite display. The term pane includes a visually defined area (for example, defined by a border, colors, or otherwise). The larger composite display optionally contains additional display panes that include applications such as viewers, editors, email clients, and web browsers. For example, FIG. 12 illustrates an additional display pane 54 positioned adjacent to the side-by-side display 50 and the conventional directory tree structure 52. In an embodiment wherein an additional display pane includes an email client, items appearing in the email client are optionally moved into a folder 22a-i by “dragging-and-dropping” the items using the cursor 26, by “cut and pasting” or otherwise. In an embodiment wherein the additional display pane includes a directory listing, electronic content is optionally moved into a folder 22a-i by “dragging-and-dropping” the items using the cursor 26, by “cut and pasting” or otherwise.

In certain embodiments, an additional display pane includes a listing of items contained in a selected folder. Such a listing is optionally sorted or filtered according to one or more user-defined criteria, such as file type, file size, creation date, modification date, etc. The additional display pane 54 is usable with the side-by-side display illustrated in FIG. 12, as well as with only the conventional directory tree structure 52, or only the flowchart graphic user interface 18.

Other techniques for moving electronic content are used in other embodiments. For example, in a modified embodiment the email client is configured to scan incoming electronic content, such as incoming email messages, for particular keywords, and then move the content to a designated folder 22a-i based on the identified keywords or addresses, if any. Optionally, the scanning can be limited to selected fields, such as the subject field, the “to” field” the “cc” field, the body field, or other field. The system is optionally configured to present the user with a list of potential destination folders if the content scanning algorithm cannot identify a folder to which the incoming email should be moved.

Optionally, the flowchart graphic user interface 18 includes a temporary staging folder where electronic content is placed for subsequent filing in a designated folder 22a-i; in such embodiments, the electronic content is placed in the temporary folder by a user and/or by an automated scanning system. In certain embodiments, the temporary folder is used to store a wide variety of different types of electronic content, including emails, spreadsheets, web pages, text documents, and word processor documents. Electronic content is also optionally movable from the flowchart graphic user interface folders to the temporary folder. For example, under one configuration, if the automated scanning system cannot identify an appropriate folder for a certain item of electronic content, the item is automatically placed in the temporary folder. In one embodiment, such a temporary folder is displayed in a separate viewing pane in the larger composite display. Items stored in the temporary folder are optionally displayed with a visual indicator, such as with a different font, with a different icon, or with a different color to alert the user to their presence in the temporary folder, and to the outstanding task of filing the electronic content in one or more appropriate designated folders 22a-i. Similar content scanning systems and temporary folders are also optionally implemented to file outgoing electronic content (for example, email) as well as incoming electronic content.

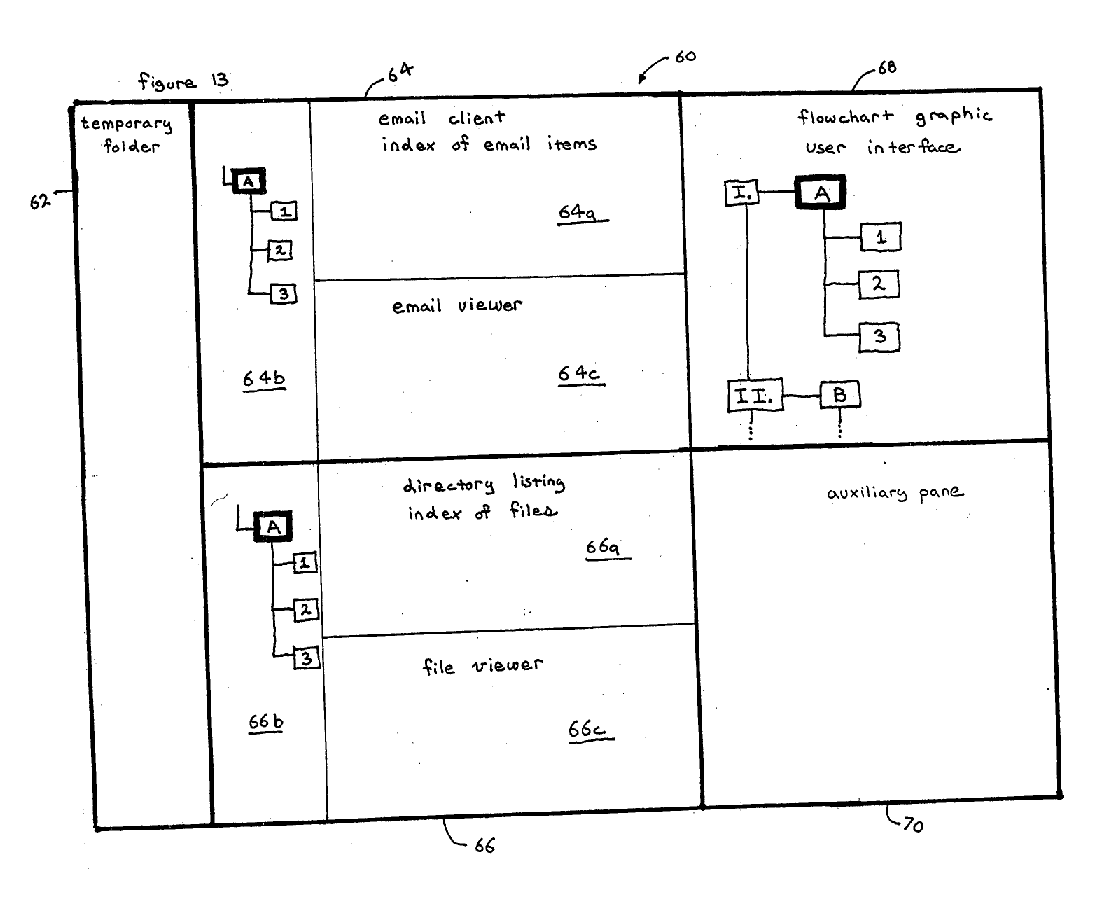

An example user interface incorporating certain features described herein is illustrated in FIG. 13. In one configuration, the example user interface provided in FIG. 13 is obtained when a user selects a folder displayed in the flowchart graphic user interface. In this exemplary embodiment, a multi-pane display 60 includes a temporary folder pane 62, an email client pane 64, a directory listing pane 66, a flowchart graphic user interface pane 68 and an auxiliary pane 70. In certain modified embodiments, one or more of the panes in the multi-pane display 60 is optional. In other modified embodiments, additional panes are added to the multi-pane display 70. For example, in one embodiment the particular configuration of the multi-pane display 70 is user configurable, thereby allowing individual users to customize the display based on individual preferences. Additionally, one or more of the panes in the multi-pane display optionally includes scroll bars or other navigation interface that enable the user to see additional information that does not fit into an individual pane.

As described herein, electronic content items which have not been moved to a flowchart graphic user interface folder optionally appear in the temporary folder, as displayed in the temporary folder pane 62. The email client pane 64 includes certain features of an email client, such as a listing of email items 64a (such as a listing of items stored in an inbox, a sent items folder, or a junk mail folder), a display of an email folder structure 64b, and an email viewer pane 64c that is useable to view email items. The directory listing pane 66 includes certain features of a file system navigator, such as a listing of items stored in a directory 66a, a conventional directory tree structure 66b (such as the conventional directory tree structure 52 illustrated in FIG. 12), and a file viewer pane 66c.

Still referring to FIG. 13, the multi-pane display 60 further optionally includes a graphical representation of all or part of a flowchart graphic user interface, such as the flowchart graphic user interface 18 illustrated in FIG. 12. In the illustrated embodiment, this is viewable in the flowchart graphic user interface pane 68. Advantageously, this allows a user to “drag-and-drop” or “cut-and-paste” items from, for example, the listing of email items 64a to one or more folders in the graphic user interface 18. The flowchart graphic user interface pane 68 is also configurable to display the selected folder in relation to other flowchart hierarchies accessible using the system disclosed herein. This advantageously provides the user with information about how the selected folder relates to other folders and/or other folder hierarchies. This also advantageously provides the user with information about the user's browsing history and what other folders a user has viewed in a particular session. The multi-pane display 60 also optionally includes an auxiliary pane 70 that can include another software application, such as another file viewer, a music player, a time recorder, or a card game.

In certain embodiments, the folders 22a-i optionally include hyperlinks to electronic content stored in a database. This allows a single item of electronic content to appear in multiple folders, and prevents multiple versions of a single item from being created when that item is accessed through different folders and/or by different users. For example, in the context of litigation, this feature enables a particular item of electronic content to be stored, for example, in a “chron” folder and a “pleading” folder, as well as a folder containing documents related to a particular project. This configuration advantageously allows the generation of index folders containing electronic content related to a particular matter, thereby facilitating searching across multiple folders in the flowchart graphic user interface.

Optionally, the user can print out a hardcopy of the flowcharts described above, or a system provider can provide hardcopies of a pre-defined or user defined electronic flowchart. The hardcopy flowcharts can be sized to be compatible with A1, A2, A3, A4, or other paper sizes, or can be poster sized intended for wall mounting. This enables a user to have consistent and easy to reference flowcharts. Further, user loyalty to use of the system can be encouraged and facilitated by such consistent flowchart representations. User loyalty to use of the system is also optionally encouraged and facilitated by first providing the hardcopy of the flowcharts (for example, by the system provider), and then subsequently providing electronic versions of the flowcharts. Example electronic versions of the flowcharts include versions accessible through a disk (that is, hosted locally), and/or versions accessible through a network or Internet connection (that is, hosted online).

### SCOPE OF THE INVENTION

While the foregoing detailed description discloses several embodiments of the present invention, it should be understood that this disclosure is illustrative only and is not limiting of the present invention. It should be appreciated that the specific configurations and operations disclosed can differ from those described above, and that the methods described herein can be used in contexts other than electronic file systems.

We claim:

1. A graphic user interface configured to be displayed on an electronic display and to be used to store electronic content, the graphic user interface comprising:
a graphically indicated first main folder;
a graphically indicated second main folder;
user defined relationship symbology displayable between the first and second main folders; and
a user prompt configured to indicate to the user that the user is to select at least one of the graphically indicated main folders with which the electronic content is to be associated, wherein the electronic content is represented as associated with the user-selected graphically indicated main folder.

2. The graphic user interface of claim 1, further comprising a graphically indicated third main folder, wherein:
the first main folder is at a first hierarchy level and has a first visual property;
the second main folder is at a first hierarchy level and has a second visual property that is different from the first visual property; and
the third main folder is at a second hierarchy level that is subordinate to the first hierarchy level.

3. The graphic user interface of claim 1 wherein the graphically indicated first and second main folders, and the user defined relationship symbology represent at least a portion of a legal process.

4. The graphic user interface of claim 1 wherein the user defined relationship symbology is selectable from at least two types.

5. The graphic user interface of claim 1 wherein the user defined relationship symbology includes loop back symbology.

6. The graphic user interface of claim 1 wherein a type of the user defined relationship symbology includes a line.

7. The graphic user interface of claim 1 wherein a type of the user defined relationship symbology includes an arrow head.

8. The graphic user interface of claim 1 wherein the first main folder includes at least one subfolder and the second main folder includes at least one subfolder, and wherein the user prompt is configured to query the user to select at least one folder from the graphically indicated main folders and the subfolders.

9. A graphic user interface system configured to be displayed on an electronic display and to be used for representation of electronic content, the graphic user interface system comprising:
a plurality of graphic user main folders;
user defined relationship symbology displayable between at least a first graphic user main folder and at least a second graphic user main folder;
and
a user prompt configured to query a user to select at least one of the graphic user main folders having user defined relationship symbology displayed therebetween, wherein the electronic content is represented as stored in the user-selected graphic user main folders.

10. The system of claim 9, wherein the plurality of graphic user main folders includes:
a first main folder that is at a first hierarchy level and that has a first visual property; and
a second main folder that is at the first hierarchy level and that has a second visual property that is different from the first visual property.

11. The system of claim 9 wherein the plurality of graphic user main folders and the user defined relationship symbology represent at least a portion of a legal process.

12. The system of claim 9 wherein the user defined relationship symbology is selectable from at least two types.

13. The system of claim 9 wherein the user defined relationship symbology includes loop back symbology.

14. The system of claim 9 wherein a type of the user defined relationship symbology includes a line.

15. The system of claim 9 wherein a type of the user defined relationship symbology includes an arrow head.

16. The system of claim 9 wherein the first graphic user main folder includes at least one subfolder and the second graphic user main folder includes at least one subfolder, and wherein the user prompt is configured to query the user to select at least one folder from the graphic user main folders and the subfolders.

17. A computer system comprising a processing unit for use with an electronic display, wherein the processing unit is configured to:
electronically communicate with the display for displaying an electronic file system graphic user interface for representation of electronic content, the graphic user interface including a graphically indicated first main folder, a graphically indicated second main folder, and relationship symbology displayable between the first and second main folders, the electronic content being represented as storable in the first and second main folders; and
at least partly in response to a user access instruction, prompt a user to select at least one of the graphically indicated main folders having relationship symbology displayed therebetween, wherein electronic content is represented as associated with the user-selected graphically indicated main folder.

18. The computer system of claim 17 wherein the relationship symbology is user defined.

19. The computer system of claim 17 wherein the relationship symbology is user defined and selectable from at least two types.

20. The computer system of claim 17 wherein the relationship symbology is user defined, and wherein a type of the user defined relationship symbology includes a line.

21. The computer system of claim 17 wherein the relationship symbology is user defined, and wherein a type of the user defined relationship symbology includes an arrow head.

22. The computer system of claim 17 wherein the graphically indicated first main folder includes at least one subfolder, and the graphically indicated second main folder includes at least one subfolder, and wherein the processing unit is configured to prompt a user to select at least one folder from the graphically indicated main folders and the subfolders.

23. A graphic user interface comprising:
a first viewing pane configured to display a directory tree structure on an electronic display, wherein the directory tree structure includes a plurality of first folders used to organize electronic content; and
a second viewing pane configured to display a flowchart structure on the electronic display, wherein the flowchart structure includes a plurality of second folders used to organize electronic content, wherein the flowchart structure includes user defined relationship symbology positioned between at least two of the second folders, and wherein at least one of the second folders is used to organize at least a portion of the same electronic content as at least one of the first folders.

24. The graphic user interface of claim 23, further comprising a user prompt configured to query a user to select a folder from the first folders and the second folders, wherein electronic content is represented as stored in the user-selected folder.

25. The graphic user interface of claim 23, further comprising a content storing module configured to:
store an electronic content in a database; and
create a hyperlink in a selected folder, wherein the selected folder is selected from the first folders and the second folders, and wherein the hyperlink is associated with the electronic content stored in the database.

26. The graphic user interface of claim 23, further comprising a scanning module configured to scan an incoming electronic content and to move the incoming electronic content to a selected folder, wherein the selected folder is selected from the first folders and the second folders.

27. The graphic user interface of claim 23, further comprising a third viewing pane that is configured to display an item selected from the first viewing pane or the second viewing pane.

28. The graphic user interface of claim 23, further comprising a third viewing pane that is configured to display a directory listing for a selected folder, wherein the selected folder is selected from the first folders and the second folders.

29. The graphic user interface of claim 23, further comprising a third viewing pane that is configured to display a portion of the flowchart graphic user interface corresponding to a selected folder.

30. Code stored in computer readable memory and configured to:
generate a graphic user interface for representation of electronic content, the graphic user interface including a graphically indicated first main folder, a graphically indicated second main folder, and relationship symbology displayable between the first and second main folders, wherein electronic content is represented as storable in at least one of the first and second main folders; and
make the graphic user interface accessible from a plurality of application software programs at least partly in response to receiving a user save instruction, wherein the user can graphically select at least one of the first and second main folders with which the user wants the electronic content to be associated with.

31. The computer system of claim 30, wherein the electronic content is represented as storable in the first and second main folders.

32. The computer system of claim 30, wherein the user save instruction is generated automatically in response to receipt of an email.

33. The computer system of claim 30, wherein the user save instruction is generated automatically in response to sending an email.

34. The computer system of claim 30, wherein the graphic user interface includes a graphically indicated third main folder that is not connected another graphically indicated main folder using the relationship symbology.

35. The computer system of claim 30, wherein the graphically indicated first main folder includes a second graphic user interface for representation of electronic content, wherein the processing unit is configured to display the second graphic user interface when the first main folder is selected by a user.

36. The computer system of claim 30, wherein the relationship symbology is user defined.

37. The computer system of claim 30, wherein the relationship symbology indicates a time sequence of events.

38. The computer system of claim 30, wherein the processing unit is further configured to supply data to an electronic content manager database based on the user-selected main folder.

39. A computer-implemented method for storing electronic content, the method comprising:
receiving a first user-defined flowchart definition that includes a plurality of folders and relationship symbology connecting at least two of the plurality of folders, wherein the plurality of folders are enabled to represent the storage of the electronic content; and
creating a directory tree structure based on the first user-defined flowchart definition, wherein the directory tree structure includes a plurality of subdirectories that correspond to the plurality of folders, and wherein the subdirectories represent the storage of the electronic content.

40. The method of claim 39, further comprising providing a printed copy of a flowchart based on the first user-defined flowchart definition before providing an electronic copy of a flowchart based on the first user-defined flowchart definition so as to familiarize the user with the flowchart definition.

41. The method of claim 39, further comprising providing via a network a graphic version of the first user-defined flowchart definition that cannot be used to store files.

42. The method of claim 39, further comprising:
receiving electronic content; and
representing the received electronic content as stored in a selected one of the plurality of folders, wherein the selected folder is selected based at least in part on the content of the received electronic content.

43. The method of claim 39, further comprising:
receiving a second user-defined flowchart definition that includes a plurality of subfolders and relationship symbology connecting at least two of the plurality of subfolders, wherein the second user-defined flowchart definition is represented as stored in one of the plurality of folders; and
creating a subdirectory tree structure based on the second user-defined flowchart definition, wherein the subdirectory tree structure is represented as stored in one of the plurality of subdirectories.

44. The method of claim 39, further comprising prompting the user for a location of the subdirectory tree structure, wherein the subdirectory tree structure is stored in a location based on a response received from the user prompt.

45. The method of claim 39, wherein the first user-defined flowchart definition is a standard template comprising a plurality of folders, wherein the standard template is selected in response to a user-selected subject matter topic.

46. The method of claim 39, further comprising:
receiving a user command to modify the first user-defined flowchart definition; and
modifying the directory tree structure based on the received user command.

47. The method of claim 39, further comprising:
receiving a user command to modify the directory tree structure; and
modifying the first user-defined flowchart definition based on the received user command.

48. The method of claim 39, further comprising:
receiving a user command to modify the first user-defined flowchart definition, wherein the user command comprises a folder rename command; and
renaming a corresponding subdirectory in the directory tree structure based on the received user command.

49. The method of claim 39, further comprising:
receiving a user command to modify the first user-defined flowchart definition, wherein the user command comprises a folder move command; and
moving a corresponding subdirectory in the directory tree structure based on the received user command.

50. The method of claim 39, further comprising:
receiving a user command to modify the directory tree structure, wherein the user command comprises a folder rename command; and
renaming a corresponding folder in the first user-defined flowchart definition based on the received user command.

51. The method of claim 39, further comprising:
receiving a user command to modify the directory tree structure, wherein the user command comprises a folder move command; and
moving a corresponding folder in the first user-defined flowchart definition based on the received user command.

52. The method of claim 39, further comprising displaying a flowchart graphic user interface based on the first user-defined flowchart definition.

53. The method of claim 39, further comprising:
displaying, in a first display pane, a flowchart graphic user interface based on the first user-defined flowchart definition; and
displaying, in a second display pane, the directory tree structure, wherein the first and second display panes are displayed simultaneously.

54. The method of claim 39, further comprising:
displaying, in a first display pane, a flowchart graphic user interface based on the first user-defined flowchart definition;
displaying, in a second display pane, a listing of electronic content stored in a selected folder in the first display pane, wherein the first and second display panes are displayed simultaneously.

55. The method of claim 39, further comprising:
displaying, in a first display pane, a flowchart graphic user interface based on the first user-defined flowchart definition;
displaying, in a second display pane, a listing of electronic content stored in a selected folder in the first display pane, wherein the first and second display panes are displayed simultaneously, and wherein the listing of electronic content is sorted based on at least one user-defined criterion.

56. The method of claim 39, further comprising:
displaying, in a first display pane, a flowchart graphic user interface based on the first user-defined flowchart definition;
displaying, in a second display pane, a listing of electronic content stored in a selected folder in the first display pane, wherein the first and second display panes are displayed simultaneously, and wherein the listing of electronic content is filtered based on type of electronic content.

57. The method of claim 39, further comprising:
displaying, in a first display pane, a flowchart graphic user interface based on the first user-defined flowchart definition;
displaying, in a second display pane, a listing of email items, wherein the first and second display panes are displayed simultaneously.

58. The method of claim 39, further comprising:
displaying, in a first display pane, a flowchart graphic user interface based on the first user-defined flowchart definition;
displaying, in a second display pane, a viewer application, wherein the first and second display panes are displayed simultaneously.

59. The method of claim 39, further comprising:
displaying, in a first display pane, a flowchart graphic user interface based on the first user-defined flowchart definition;
displaying, in a second display pane, a listing of temporarily stored items, wherein the first and second display panes are displayed simultaneously.

60. The method of claim 39, wherein placement of the plurality of subdirectories in the directory tree structure depends in part on the relationship symbology.

61. The method of claim 39, wherein placement of the plurality of subdirectories in the directory tree structure depends in part on a relative location of the plurality of folders in the first user-defined flowchart definition.

62. The method of claim 39, wherein placement of the plurality of subdirectories in the directory tree structure depends in part on user input received in response to a location query provided to the user.
